(19) United States
(12) Patent Application Publication
(10) Pub. No.: US 2017/0334691 A1
(43) Pub. Date: Nov. 23, 2017

(54) LIFTING MECHANISM FOR AN APPARATUS FOR LIFTING CONSTRUCTION PLATES, LIFTING APPARATUS COMPRISING THIS MECHANISM, AND LIFTING METHOD USING THIS APPARATUS

(71) Applicant: ÉTABLISSEMENTS PIERRE GRÉHAL ET CIE SA, Baillet en France (FR)

(72) Inventor: Lionel MARCON, Parmain (FR)

(21) Appl. No.: 15/523,682

(22) PCT Filed: Oct. 2, 2015
(86) PCT No.: PCT/FR2015/052659

§ 371 Date: May 2, 2017

(30) Foreign Application Priority Data
Nov. 6, 2014 (FR) FR1460718

(51) Int. Cl. B66F 3/02; E04F 21/18; B66F 17/00

(52) U.S. Cl. CPC B66F 3/02; B66F 17/00; E04F 21/1811

(57) ABSTRACT

The present invention proposes a silent, safe, fast, multi-purpose and easy-to-service lifting mechanism. For this purpose, the mechanism comprises: a telescopic mast with a fixed segment (11) and a first telescopic segment (12) mounted so as to slide inside the fixed segment; a rack (13) having a set width and provided with teeth (131), which is attached to the first telescopic segment; a gear system comprising: a pinion (21) directly meshed with the rack, a driving shaft (22) which meshes with the pinion and is attached to a steering wheel, a reversible locking means for the driving shaft, designed to lock the driving shaft against rotation as long as no action is taken by a user.

The invention relates to a lifting mechanism for an apparatus for lifting construction plates, to an apparatus for lifting construction plates comprising such a mechanism as well as to a method for lifting construction plates by means of such an apparatus.

In particular, the invention relates to lifting and handling apparatuses which are used during jobs for handling and positioning heavy objects, such as plates of material (plasterboard, wood paneling, etc.) in order to realize false ceilings or for the arrangement of sloping ceilings or partitioning.

Said type of apparatus, called a plate lifter, has already been described, for example in document FR2538437.

The general structure of a plate lifter is as follows: a telescopic mast which is controllable by means of a lifting mechanism and is mounted on a rolling base. A plate support is pivotably mounted at the end of the mast by means of a pivoting mechanism.

The telescopic mast comprises a first fixed element, and at least one telescopic element which is movable in relation to the fixed element. Generally, the mast comprises two movable telescopic elements.

There are two types of lifting mechanism.

The most widespread, shown in document FR2538437, is a hauling system which comprises a winch, several idler pulleys and a cable connected to the winch which passes through the pulleys and through the telescopic elements of the mast.

The realization of a double ratchet winch, which is connected to a traction (lifting) cable and to a safety cable (in case the traction cable breaks), has been proposed so as to improve the safety of such a mechanism. Such a device is described in document FR2758150. However, said mechanism is very noisy: 87 dB (measured using the “Decibel Ultra” ® app on an iPhone®, at 30 cm from the winch and with an ambient noise of 31 dB). Furthermore, the metal cables used wear very quickly and can either break or fray, risking injury to the user.

Furthermore, as the mechanism is accessible, the risk of a user trapping his fingers is very real. Finally, the telescopic elements of the mast must have open profiles in order to allow the cables to pass through easily when the mast is being raised or lowered. Such a structure weakens the mechanical strength of the mast.

The second type of lifting mechanism is an endless screw-motorized mechanism which engages with one of the telescopic elements of the mast. Said device is described in document EP0969165. The plate lifter comprises a motor, the shaft of which is coupled to an endless screw by means of an idler pulley assembly.

The endless screw is arranged in the interior of the mast in a coaxial manner and is guided in the interior of the telescopic mast.

The endless screw engages with a bearing nut which is integral with the first movable element of the telescopic mast. The second movable element is raised by cables which tighten when the first movable element rises.

To this end, the second movable element is formed by an open profile, with a form that is complementary to the first movable element so as to be guided during the lift so as to allow the cable to pass freely.

The lift and the descent are controlled solely by the motor. It is therefore impossible to bring the mast down again if power is no longer supplied to the motor.

Furthermore, such a plate lifter has a very heavy weight and takes up a large amount of space as it includes not only a fixed motor which is remote compared to the mast, but also the power source, in most cases a battery.

In addition, the dimensioning of the telescopic elements of the mast has to be done in as appropriate a manner as possible in order to ensure the plate lifter has good stability, notably when the mast is deployed (top position of the plate lifter). Friction is therefore high and requires a good deal of power input. Furthermore, there is a good deal of wear and tear.

The present invention therefore aspires to propose a lifting mechanism which, advantageously for a plate lifter, is quiet, safe (that is to say prevents risk of injury to the user), fast, versatile (that is to say can be actuated by a motor or manually), and is easily maintained.

To this end, the object of the invention is a lifting mechanism for a lifting tool comprising, with reference to the position of use:
a telescopic mast which comprises a fixed segment and a first telescopic segment which is mounted so as to slide in the interior of the fixed segment;
a rack which has a set width, is provided with teeth and is fixed to the first telescopic segment;
a gearing system comprising:
   a pinion which is in direct engagement with the rack;
   a control shaft which is in engagement with the pinion and is fixed to a control wheel;
a means for reversibly locking the control shaft, provided for blocking the rotation of the control shaft in the absence of any action on the part of a user.

According to other embodiments:
the rack can be fixed on the first telescopic segment so that the teeth of the rack are perpendicular to the first telescopic segment;
the control shaft can be indirectly engaged with the pinion by means of a reduction system, which is arranged such that the pinion rotates at a faster speed than the control shaft;
the reversible locking means can be a manually actuatable lever brake which is arranged to block the control shaft from rotating;
the lever brake can include:
   a lever which is mounted so as to pivot in relation to the control shaft, the lever comprising a grip end, a part for fixing to a rotational axis and an abutment end;
   a flexible loop which is provided with a brake lining and is arranged around the control shaft, a first end of the loop being fixed on the lever in an off-center manner with respect to the rotational axis of the lever, and a second end of the loop being fixed in an adjustable manner on the lever,
   a restoring means which is in abutment against the abutment end of the lever and restricts the rotation of the lever such that the loop is tightened around the control shaft in the absence of any action on the part of a user;
the second end of the loop can be fixed on a part which is mounted so as to slide on and in relation to the lever and is retained on the lever in an adjustable manner;
the lever brake can include:
   a lever which is mounted so as to pivot in relation to the control shaft, the lever comprising a grip end, a part for fixing to a rotational axis and an abutment end;
   a dome which is integral with the control shaft and in the interior of which at least two jaws, which are provided with seals which are connected to the lever by means of cams, are mounted in a movable manner,
   a restoring means which is in abutment against the abutment end of the lever and restricts the rotation of the lever such that the two jaws rub against the dome in the absence of any action on the part of a user;
the lever brake can include:
   a lever which is mounted so as to pivot in relation to the control shaft, the lever comprising a grip end, a part for fixing to a rotational axis and an abutment end;
   a disk which is integral with the control shaft, on both sides of which two jaws, which are provided with brake pads which are connected to the lever by means of cams, are mounted so as to be movable,
   a restoring means which is in abutment against the abutment end of the lever and restricts the rotation of the lever such that the two jaws rub against the disk in the absence of any action on the part of a user;
the mechanism can comprise, furthermore, a second telescopic segment which is mounted so as to slide in the interior of the first telescopic segment;
the fixed segment can have a rectangular section, the first telescopic segment can have a square section and the second telescopic segment can have a circular section;
the second telescopic segment can have an outside diameter which is less than or equal to an inside edge of the first telescopic segment, and the fixed segment with the rectangular section can have:
   a short interior side which is in excess of or equal to an outside edge of the first telescopic segment, and
   a long interior side which is in excess of or equal to an outside edge of the first telescopic segment plus the width of the rack;
the mechanism can comprise, furthermore, at least one traction cable, a first end of which is fixed to the fixed segment and a second end is fixed to a lower end of the second telescopic segment, with respect to the position of use, said at least one cable being engaged around a pulley which is fixed to an upper end of the first telescopic segment, with respect to the position of use;
the circular second telescopic segment can include a lower end which is provided with a notch and is soldered to a profile with a square section which is less than or equal to an inside section of the first telescopic segment, the profile being provided with a holding hook for the traction cable;
the control wheel comprises a crank which is mounted so as to pivot between a retracted position where the crank is parallel with the wheel, and an operating position where the crank is perpendicular to the plane of the wheel;
the control shaft passes through the wheel and has an end which is provided with a connector for fixing to a complementary connector which is carried by a portable electric screwdriver;
the control shaft is fixed to the control wheel by means of a unidirectional roller; and/or
the mechanism can comprise, furthermore, a means for forcing the rack against the pinion.

Another object of the invention is also a lifting apparatus for lifting a construction plate, characterized in that said lifting apparatus comprises:
an above-described lifting mechanism,
a rolling base which is fixed to a first end of the mast of said mechanism;
a plate carrier which is mounted so as to pivot at another end of the mast.

Another object of the invention is also a method for implementing an above-described lifting apparatus, said method comprising the following steps:
a1) supply an above-described lifting apparatus;
b1) place a plate on the plate carrier and position the apparatus at a location which has been adapted for the plate;
c1) actuate the reversible locking means of the control shaft in order to unlock the rotation of the control shaft;
d1) turn the control wheel until the telescopic mast is deployed and the plate is in the fixing position;
e1) release the locking means in order to block the rotation of the control shaft;
f1) fix the plate;
g1) actuate the reversible locking means of the control shaft in a gradual manner in order to unlock the rotation of the control shaft and allow the mast to descend due to gravity, in a gradual and controlled manner.

Another object of the invention is also a method for implementing an above-described lifting apparatus, said method comprising the following steps:
a2) supply an above-described lifting apparatus which is provided with an above-described mechanism, the control shaft of which passes through the wheel and has an end which is provided with a connector for fixing to a complementary connector which is carried by a portable electric screwdriver;
b2) place a plate on the plate carrier and position the apparatus at a location which has been adapted for the plate;
c2) position a portable electric screwdriver which is provided with a connector which is
complementary to the connector which is carried by the end of the control shaft; d2) actuate the reversible locking means of the control shaft in order to unlock the rotation of the control shaft;
e2) actuate the portable electric screwdriver until the telescopic mast is deployed and the plate is in the fixing position;
f2) release the locking means in order to block the rotation of the control shaft;
g2) fix the plate;
h2) actuate the reversible locking means of the control shaft in a gradual manner in order to unlock the rotation of the control shaft and allow the mast to descend due to gravity, in a gradual and controlled manner.

Other characteristics of the invention will be outlined in the detailed description below, which is given with reference to the accompanying drawings, in which, respectively:

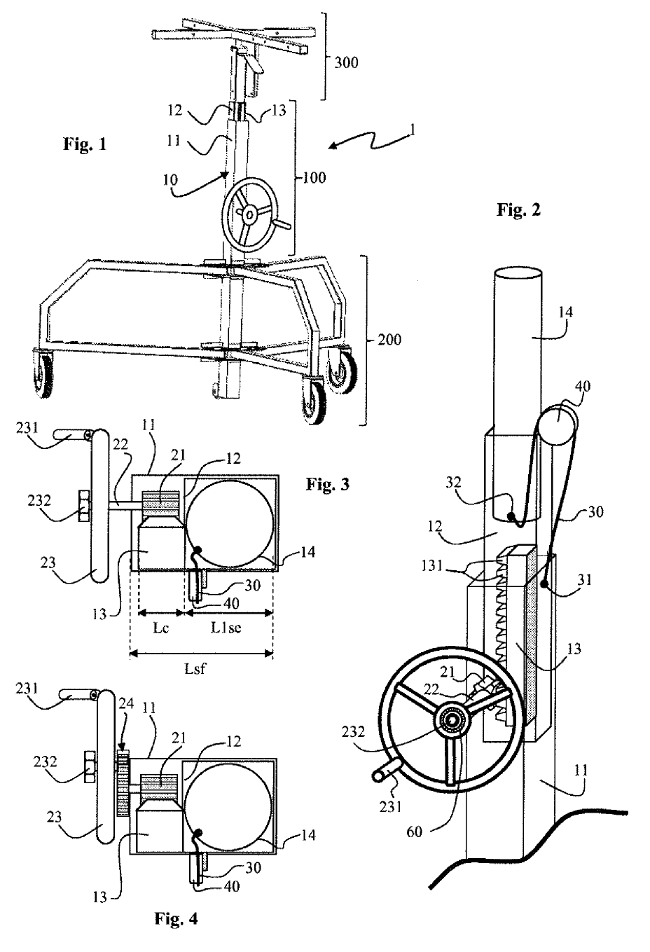

FIG. 1 shows a schematic view in perspective of a plate lifter which is provided with a first embodiment of a lifting mechanism according to the invention;

FIG. 2 shows a schematic view in partial perspective of the lifting mechanism of FIG. 1;

FIG. 3 shows a schematic top view seen from above of the mechanism of FIG. 2;

FIG. 4 shows a schematic top view seen from above of the second embodiment of a mechanism according to the invention;

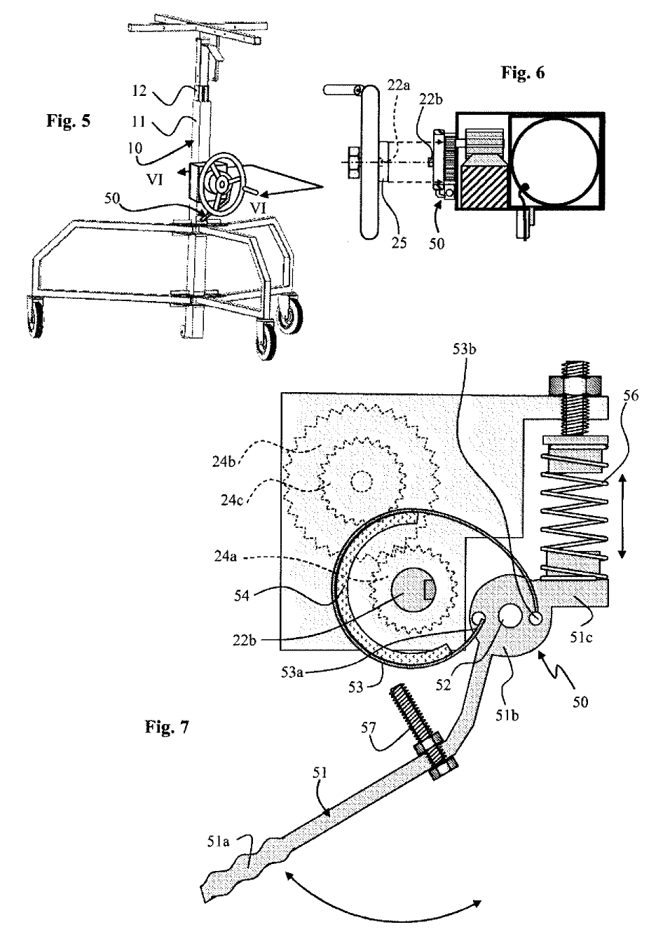

FIG. 5 shows a schematic view in perspective of a plate lifter which is provided with a third embodiment of a lifting mechanism according to the invention;

FIG. 6 shows a partially exploded, schematic view in section of the mechanism of FIG. 5 according to the line VI-VI;

FIG. 7 shows a schematic top view of an embodiment of a brake which can be fitted in the third embodiment of the lifting mechanism according to the invention;

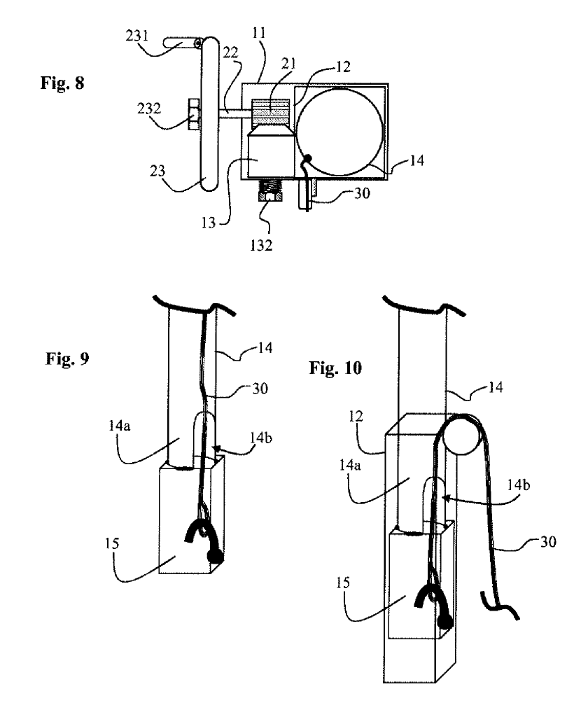

FIG. 8 shows a schematic top view seen from above of the mechanism of FIG. 3, provided with a means for forcing the rack against the mechanism; and

FIGS. 9 and 10 show schematic views in partial perspective of an advantageous embodiment of the mast of a lifting mechanism according to the invention.

FIG. 1 shows a plate lifter provided with a lifting mechanism according to the invention in the position of use. The plate lifter 1 comprises a lifting mechanism 100 to which is fixed a rolling base 200 and a plate support 300.

The lifting mechanism 100 comprises a telescopic mast 10 which comprises a fixed segment 11 and a first telescopic segment 12 which is mounted so as to slide in the interior of the fixed segment 11. A straight rack 13 is fixed along the first telescopic segment 11.

The rack 13 engages with a gearing system which is shown in more detail in FIGS. 2 and 3. In FIG. 2, the segments of the mast are shown in a transparent manner to make it easier to understand.

The gearing system 20 comprises a pinion 21 which is in direct engagement with the rack 13, and a control shaft 22, which is in engagement with the pinion 21, is fixed to a control wheel 23. The control shaft 22 passes through the wall of the fixed segment 11.

The lifting mechanism according to the invention also comprises a means for reversibly locking the control shaft which is provided in order to block the rotation of the control shaft 22 in the absence of any action on the part of a user. In other words, whatever the state of extension of the telescopic mast, if the user releases the control wheel, the mast remains in position and does not come down again due to gravity.

Said locking means will be described in more detail in relation with figures five to seven.

In accordance with the invention, and as shown in detail in figures two and three, the rack 13 is fixed on the first telescopic segment 12 so that the teeth 131 of the rack 13 are perpendicular to the first telescopic segment 12.

Said arrangement allows the space required by the lifting mechanism and, in particular by the gearing system, to be minimized.

FIG. 4 shows an advantageous embodiment in which the control shaft 22 is indirectly engaged with the pinion 21 by means of a reduction system 24 which is arranged such that the pinion 21 rotates faster than the control shaft 22.

Such a mechanism allows the telescopic mast to be raised quickly and effortlessly.

Said lifting mechanism is extremely quiet compared to ratchet winch systems: it only generates 46 dB (measured using the “Decibel Ultra”® app on an iPhone®, at 30 cm from the winch and with an ambient noise of 31 dB), whilst a ratchet winch system which complies with document FR2758150 generates 87 dB.

In an advantageous manner, the lifting mechanism according to the invention comprises, moreover, a second telescopic segment 14 which is mounted so as to slide in the interior of the first telescopic segment 12.

According to a preferred embodiment of the invention, the fixed segment 11 has a rectangular section, the first telescopic segment 12 has a square section and the second telescopic segment 14 has a circular section.

The second telescopic segment 14 has an outside diameter D2s which is less than or equal to an inside edge of the first telescopic segment 12. The second telescopic segment 14 therefore only has four lines of contact with the first telescopic segment 12, which minimizes the friction (and therefore the exertion required to raise the mast), while ensuring precise guiding between the two segments.

The fixed segment 11 with the rectangular section has a short interior side with a dimension in excess of or equal to the outside edge L1s of the first telescopic segment 12, and a long interior side with a dimension Lsf which is in excess of or equal to the outside edge L1s of the first telescopic segment plus the width Lc of the rack 13.

The lifting mechanism according to the invention allows therefore not only precise guiding which minimizes friction, but also the space required is minimized since the pinion 21 and the rack 13 are housed inside the fixed segment 11 of the mast 10.

So as to allow the second telescopic segment 14 to be raised, the mechanism according to the invention comprises a traction cable 30, a first end 31 of which is fixed to the fixed segment 11 and a second end 32 is fixed to a lower end of the second telescopic segment 14.

The cable 30 is engaged around an idler pulley 40 which is fixed to an upper end of the first telescopic segment 12.

Thus, when the wheel 23 rotates around the control shaft 22, the first telescopic segment is raised upward by means of the pinion 21 and the rack 13. The pulley 40, which is fixed to the first telescopic segment 12, moves up the same time. The cable 30 is therefore tightened and the second telescopic segment 14 moves up.

The fact that the second telescopic segment 14 has a circular section and the first telescopic segment 12 has a square section allows a space to be provided in which the cable 30 is able to extend without the risk of jamming between the two telescopic segments.

FIGS. 9 and 10 show an embodiment of the mast allowing for such an arrangement.

In said embodiment, the second telescopic segment with the circular section 14 comprises a lower end 14a which is provided with a notch 14b and is soldered to a profile 15 with a square section which is less than or equal to the inside section of the first telescopic segment 12. So as to enable the traction cable 30 to be attached, the interior of the profile is provided with a holding hook for the traction cable 30.

Thus, by means of the notch 14b and to the difference in the sectional form of the second telescopic segment 14 and of the profile 15, the cable can be easily fixed in the second telescopic segment.

The use of a profile with a square section which is less than or equal to the inside section of the first telescopic segment 12 allows the second telescopic segment with the circular section 14 to be guided in an effective manner in the first telescopic segment 12 with the square section.

In a preferred manner, the lower end 14a, which is provided with a notch 14b, is soldered to a profile 15 with a square section such that the notch covers a corner of the profile 15, which allows an adequate passage to be left for the cable 30 preventing it from being crushed between the two telescopic segments 14 and 12.

By means of said arrangement, it is not necessary to use open profiles to build the telescopic segments, as in the prior art, such that the segments used in the lifting mechanism according to the invention are structurally more robust, all else being equal.

Furthermore, the kinematics are very fast since in the lifting mechanism according to the invention, the middle segment and the inside segment are raised simultaneously, while the first telescopic segment is raised outside the fixed segment and the second telescopic segment is raised outside the first telescopic segment.

So as to facilitate the actuation of the lifting mechanism, the control wheel 23 is provided with a crank 231, which, in a preferred manner, is pivotably mounted on the control wheel. Thus, the crank 231 has an operating position in which it is perpendicular to the plane of the control wheel 23 (see FIG. 2) and a retracted position in which the crank is parallel to the wheel. In said latter position, the crank 231 is not likely to cause an injury to a user when the mast comes down again due to gravity.

FIGS. 5 to 7 show the means for reversibly locking the control shaft 22 in a more precise manner.

According to the invention, said reversible locking means is provided to block the control shaft from rotating in the absence of any action on the part of a user.

According to a preferred embodiment, the reversible locking means 50 is a lever brake which can be actuated manually and is arranged to block the control shaft from rotating.

According to a first embodiment, the lever brake 50 comprises, with reference to FIG. 7:
a lever 51 which is mounted so as to pivot in relation to the control shaft 22, the lever comprising a grip end 51a, a part for fixing 51b to a rotational axis 52 and an abutment end 51c;
a flexible loop 53 which is provided with a brake lining 54 and is arranged around the control shaft, a first end 53a of the loop being fixed on the lever 51 in an offset manner in relation to the rotational axis 52 of the lever, and a second end 53b of the loop being fixed in an offset manner in relation to the rotational axis 52 of the lever and in relation to the first end 53a. In an embodiment not shown, the second end 53b can be fixed in an adjustable manner on the lever. For example, the second end of the loop could be fixed on a part which is mounted so as to slide on and in relation to the lever 51, and is held on the lever in an adjustable manner by means of an adjusting nut;
a restoring means 56, which is in abutment against the abutment end 51c of the lever and restricts the rotation of the lever so that the loop is tightened around the control shaft in the absence of any action on the part of a user.

According to an embodiment, a crown 25, which is fixed to the control shaft 22, is advantageously provided in order to provide an upper friction surface with the brake.

Advantageously, the lever also comprises an adjustable end stop 57 which avoids the user loosening the brake too much.

By means of said arrangement, and in particular by means of the restoring means 56, the user has to actuate the brake by loosening it to unlock the control shaft and to be able to rotate the control wheel in order to raise the telescopic mast. If he lets go of the brake, the mast cannot move down again, ensuring his safety. Brake application is thus obtained in the absence of any operation, by coupling the arm to a spring-type elastic restoring means. Thus, in the absence of any force against the spring, the brake prevents the control shaft from rotating.

More precisely, in order to implement a lifting apparatus which is provided with a lifting mechanism according to the invention, the user:
b1) places a plate on the plate carrier and positions the apparatus at a location which has been adapted for the plate;
c1) actuates the reversible brake of the control shaft in order to unlock the rotation of the control shaft;
d1) turns the control wheel until the telescopic mast is deployed and the plate is in the fixing position;
e1) releases the brake in order to block the rotation of the control shaft;
f1) fixes the plate;
g1) actuates the brake of the control shaft in a gradual manner in order to unlock the rotation of the control shaft and allow the mast to descend due to gravity, in a gradual and controlled manner.

According to another embodiment which is not shown, the lever brake comprises:
a lever which is mounted so as to pivot in relation to the control shaft, the lever comprising a grip end, a part for fixing to a rotational axis and an abutment end;
a dome which is integral with the control shaft and in the interior of which at least two jaws, which are provided with seals which are connected to the lever by means of cams, are mounted in a movable manner,
a restoring means which is in abutment against the abutment end of the lever and restricts the rotation of the lever such that the two jaws rub against the dome in the absence of any action on the part of a user.

According to another embodiment which is not shown, the lever brake comprises:
a lever which is mounted so as to pivot in relation to the control shaft, the lever comprising a grip end, a part for fixing to a rotational axis and an abutment end;
a disk which is integral with the control shaft, on both sides of which two jaws, which are provided with brake pads which are connected to the lever by means of cams, are mounted so as to be movable,
a restoring means which is in abutment against the abutment end of the lever and restricts the rotation of the lever such that the two jaws rub against the disk in the absence of any action on the part of a user.

In an advantageous manner, as shown in FIG. 6, the control shaft 22 is in two removable parts, the one 22a being integral with the control wheel 23, and the other 22b remaining in direct or indirect engagement (via the reduction system) with the pinion. This allows the wheel to be removed and the brake to be maintained.

As an alternative to this or combined with it, the control shaft passes through the wheel and has an end which is provided with a connector 232 for fixing to a complementary connector which is carried by a portable electric screwdriver. It is thus possible to actuate the lifting mechanism by a screwdriver, which minimizes the effort that has to be supplied.

In a preferred embodiment, which is particularly adapted for the use of a screwdriver, the reduction system 24 comprises:
a first pinion 24a which is integral with the control shaft (or with part 22b), having an internal radius (bottom of tooth) of 13.5 mm, an external radius (end of tooth) of 18 mm, and 16 teeth;
a sprocket 24b which engages with the first pinion 24a, and has an internal radius (bottom of tooth) of 49.5 mm, an external radius (end of tooth) of 54 mm, and 52 teeth;
a second concentric pinion 24c which is integral with the sprocket 24b, engages with the rack 13, and has an internal radius (bottom of tooth) of 13.5 mm, an external radius (end of tooth) of 18 mm, and 16 teeth.

Said embodiment is particularly advantageous as it enables a large amount of power transmission such that neither a user in manual mode nor the screwdriver tire, while ensuring the mast is raised at a speed which is in excess of speeds generally ascertained with plate lifters in the prior art.

Thus, in a comparison with the “levpano I®” and “levpano II®” (kr models from Roger Mondelin, the following results are obtained:

| | | Maximum power required |
|---|---|---|
| | Lift speed in mm per | during a crank revolution |
| | crank revolution | (levpano ®) or wheel |
| | (levpano ®) or wheel | revolution (invention) (in |
| | revolution (invention) | DaN) |
| levpano ® | 57 mm | 5.8 |
| Invention | 60 mm | 4.7 |

The power has been measured using a Kern dynamometer, HCB model version 3.1 July 2006.

In combination, according to an embodiment of the invention which is of particular interest, the control shaft 22 (or part 22b) is fixed to the control wheel 23 by means of a unidirectional roller 60 (see FIG. 2).

By means of said type of roller, if the control shaft 22 (or part 22a) is meshed with a portable electric screwdriver, the control shaft 22 can rotate at high speed in the direction of lifting the mast without entraining the wheel.

Screwdrivers are used on-site very frequently and it is very easy to recharge them.

Moreover, in the configuration according to the invention, the screwdriver is situated in front of the user, which provides him with an optimum position for controlling both the brake and the screwdriver at the same time.

When the mast is raised in the position for fixing the plate, the user releases the brake, thus blocking the rotation of the control shaft, and withdraws the screwdriver to minimize the space required by the whole assembly.

FIG. 8 shows an embodiment of a lifting mechanism according to the invention, which comprises, moreover, a means for forcing 132 the rack 13 against the pinion 21.

In FIG. 8, said forcing means is constituted by a screw.

Such a mechanism is useful in order to adjust the lifting mechanism and to ensure the rack is engaged correctly against the pinion 21.

1. A lifting mechanism (100) comprising, with reference to the position of use:
a telescopic mast (10) which comprises a fixed segment (11) and a first telescopic segment (12) which is mounted so as to slide in the interior of the fixed segment (11);
a rack (13) which has a set width (Lc), is provided with teeth (131) and is fixed to the first telescopic segment;
a gearing system (20) comprising:
a pinion (21) which is in direct engagement with the rack (13);
a control shaft (22, 22a-22b) which is in engagement with the pinion (21) and is fixed to a control wheel (23);
a means (50) for reversibly locking the control shaft, provided for blocking the rotation of the control shaft in the absence of any action on the part of a user.

2. The mechanism as claimed in claim 1, in which the rack (13) is fixed on the first telescopic segment (11) so that the teeth (131) of the rack are perpendicular to the first telescopic segment (11).

3. The mechanism as claimed in claim 1, in which the control shaft (22, 22a-22b) is indirectly engaged with the pinion (21) by means of a reduction system (24), which is arranged such that the pinion (21) rotates at a faster speed than the control shaft (22, 22a-22b).

4. The mechanism as claimed in claim 1, in which the reversible locking means is a manually actuatable lever brake which is arranged to block the control shaft from rotating.

5. The mechanism as claimed in claim 4, in which the lever brake (50) includes:
a lever (51) which is mounted so as to pivot in relation to the control shaft, the lever comprising a grip end (51a), a part for fixing (51b) to a rotational axis (52) and an abutment end (51c);
a flexible loop (53) which is provided with a brake lining (54) and is arranged around the control shaft (22, 22a-22b), a first end (53a) of the loop being fixed on the lever, and a second end (53b) of the loop being fixed in an adjustable manner on the lever,
a restoring means (56) which is in abutment against the abutment end of the lever and restricts the rotation of the lever such that the loop is tightened around the control shaft in the absence of any action on the part of a user.

6. The mechanism as claimed in claim 5, in which the second end of the loop is fixed on a part (55) which is mounted so as to slide on and in relation to the lever and is retained on the lever in an adjustable manner.

7. The mechanism as claimed in claim 4, in which the lever brake includes:
a lever which is mounted so as to pivot in relation to the control shaft, the lever comprising a grip end, a part for fixing to a rotational axis and an abutment end;
a dome which is integral with the control shaft and in the interior of which at least two jaws, which are provided with seals which are connected to the lever by means of cams, are mounted in a movable manner,
a restoring means which is in abutment against the abutment end of the lever and restricts the rotation of the lever such that the two jaws rub against the dome in the absence of any action on the part of a user.

8. The mechanism as claimed in claim 4, in which the lever brake includes:
a lever which is mounted so as to pivot in relation to the control shaft, the lever comprising a grip end, a part for fixing to a rotational axis and an abutment end;
a disk which is integral with the control shaft, on both sides of which two jaws, which are provided with brake pads which are connected to the lever by means of cams, are mounted so as to be movable,
a restoring means which is in abutment against the abutment end of the lever and restricts the rotation of the lever such that the two jaws rub against the disk in the absence of any action on the part of a user.

9. The mechanism as claimed in claim 1, comprising, furthermore, a second telescopic segment (14) which is mounted so as to slide in the interior of the first telescopic segment.

10. The mechanism as claimed in claim 9, in which:
a) the fixed segment (11) has a rectangular section;
b) the first telescopic segment (12) has a square section;
c) the second telescopic segment (14) has a circular section.

11. The mechanism as claimed in claim 10, in which:
the second telescopic segment (14) has an outside diameter (D2s) which is less than or equal to an inside edge of the first telescopic segment (12), and
the fixed segment (11) with the rectangular section has:
a short interior side which is in excess of or equal to an outside edge of the first telescopic segment, and
a long interior side (Lsf) which is in excess of or equal to an outside edge (L1se) of the first telescopic segment plus the width (Lc) of the rack (13).

12. The mechanism as claimed in claim 10, comprising, furthermore, at least one traction cable (30), a first end (31) of which is fixed to the fixed segment (11) and a second end (32) is fixed to a lower end of the second telescopic segment (14), with respect to the position of use, said at least one traction cable being engaged around a pulley (40) which is fixed to an upper end of the first telescopic segment (12), with respect to the position of use.

13. The mechanism as claimed in claim 12, in which the circular second telescopic segment (14) includes a lower end which is provided with a notch and is soldered to a profile with a square section which is less than or equal to an inside section of the first telescopic segment (12), the profile being provided with a holding hook for the traction cable (30).

14. The mechanism as claimed in claim 1, in which the control wheel (23) comprises a crank (231) which is mounted so as to pivot between a retracted position where the crank is parallel with the wheel, and an operating position where the crank is perpendicular to the plane of the wheel.

15. The mechanism as claimed in claim 1, in which the control shaft passes through the wheel and has an end which is provided with a connector (232) for fixing to a complementary connector which is carried by a portable electric screwdriver.

16. The mechanism as claimed in claim 15, in which the control shaft is fixed to the control wheel by means of a unidirectional roller (60).

17. The mechanism as claimed in claim 1, comprising, furthermore, a means for forcing (132) the rack (13) against the pinion (21).

18. A lifting apparatus for lifting a construction plate, characterized in that said lifting apparatus comprises:
a mechanism as claimed in claim 1,
a rolling base which is fixed to a first end of the mast of said mechanism;
a plate carrier which is mounted so as to pivot at another end of the mast.

19. A method for implementing a lifting apparatus comprising the following steps:
a1) supply an apparatus as claimed in claim 18;
b1) place a plate on the plate carrier and position the apparatus at a location which has been adapted for the plate;
c1) actuate the reversible locking means of the control shaft in order to unlock the rotation of the control shaft;
d1) turn the control wheel until the telescopic mast is deployed and the plate is in the fixing position;
e1) release the locking means in order to block the rotation of the control shaft;
f1) fix the plate;
g1) actuate the reversible locking means of the control shaft in a gradual manner in order to unlock the rotation of the control shaft and allow the mast to descend due to gravity, in a gradual and controlled manner.

20. The method for implementing a lifting apparatus comprising the following steps:
a2) supply an apparatus as claimed in claim 18, wherein said apparatus includes a control shaft passes through the wheel and has an end which is provided with a connector (232) for fixing to a complementary connector which is carried by a portable electric screwdriver, the control shaft fixed to the control wheel by means of a unidirectional roller (60);
b2) place a plate on the plate carrier and position the apparatus at a location which has been adapted for the plate;
c2) position a portable electric screwdriver which is provided with a connector which is complementary to the connector which is carried by the end of the control shaft;
d2) actuate the reversible locking means of the control shaft in order to unlock the rotation of the control shaft;
e2) actuate the portable electric screwdriver until the telescopic mast is deployed and the plate is in the fixing position;
f2) release the locking means in order to block the rotation of the control shaft;
g2) fix the plate;
h2) actuate the reversible locking means of the control shaft in a gradual manner in order to unlock the rotation of the control shaft and allow the mast to descend due to gravity, in a gradual and controlled manner.
